(19) United States
(12) Patent Application Publication
(10) Pub. No.: US 2006/0221238 A1
(43) Pub. Date: Oct. 5, 2006

(54) Image output apparatus and image output method

(76) Inventor: Motohiro Takayama, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/373,993

(22) Filed: Mar. 14, 2006

(30) Foreign Application Priority Data
Mar. 14, 2005 (JP) 2005-071107

(51) Int. Cl. H04N 5/45; H04N 5/50

(52) U.S. Cl. 348/565; 348/731

(57) ABSTRACT

According to one embodiment, an image output method comprises causing a second signal processing unit to select a second channel and decode an image signal on the second channel while causing a first signal processing unit to continue outputting a decoded image on a first channel on the basis of an instruction to switch to the decoded image output on the second channel while the first signal processing unit is outputting the decoded image on the first channel, and switching from the decoded image output on the first channel from the first signal processing unit to the decoded image output on the second channel from the second signal processing unit as a result of the completion of the preparation of the decoded image signal output on the second channel by the second signal processing unit.

### CROSS-REFERENCE TO RELATED APPLICATIONS

This application is based upon and claims the benefit of priority from Japanese Patent Application No. 2005-071107, filed Mar. 14, 2005, the entire contents of which are incorporated herein by reference.

### BACKGROUND

1. Field

One embodiment of the invention relates to an image output apparatus and a image output method which output an image signal on the selected channel.

2. Description of the Related Art

With the recent start of digital broadcast, various proposals regarding a digital broadcast receiving apparatus have been made. For example, the technique for eliminating the discomfort associated with the channel switching waiting time in digital broadcasting has been proposed in Jpn. Pat. Appln. KOKAI Publication No. 2004-336481. The technique is such that the content prepared in the memory is output during the channel switching waiting time, thereby getting rid of the discomfort associated with the waiting time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 schematically shows the configuration of a digital broadcast receiving apparatus (or image output apparatus) according to a first embodiment of the invention;

FIG. 2 shows the relationship between a main screen and a sub-screen according to the first embodiment;

FIG. 3 is a diagram to help explain channel switching control performed by the digital broadcast receiving apparatus of FIG. 1 according to the first embodiment;

FIG. 4 schematically shows the configuration of a digital broadcast receiving apparatus (or image output apparatus) according to a second embodiment of the invention; and

FIG. 5 is a diagram to help explain an example of a transient special effect (or cross-fade effect) produced by the digital broadcast receiving apparatus of FIG. 4 according to the second embodiment of the invention.

### DETAILED DESCRIPTION

Various embodiments according to the invention will be described hereinafter with reference to the accompanying drawings. In general, an image output method according to one embodiment of the invention comprises causing a second signal processing unit to start to select a second channel and decode a second-channel image signal while causing a first signal processing unit to continue outputting a first-channel decoded images on the basis of an instruction to switch to the output of a second-channel decoded image given while the first signal processing unit is outputting the first-channel decoded image, and switching from the first-channel decoded image output from the first signal processing unit to the second-channel decoded image output from the second signal processing unit.

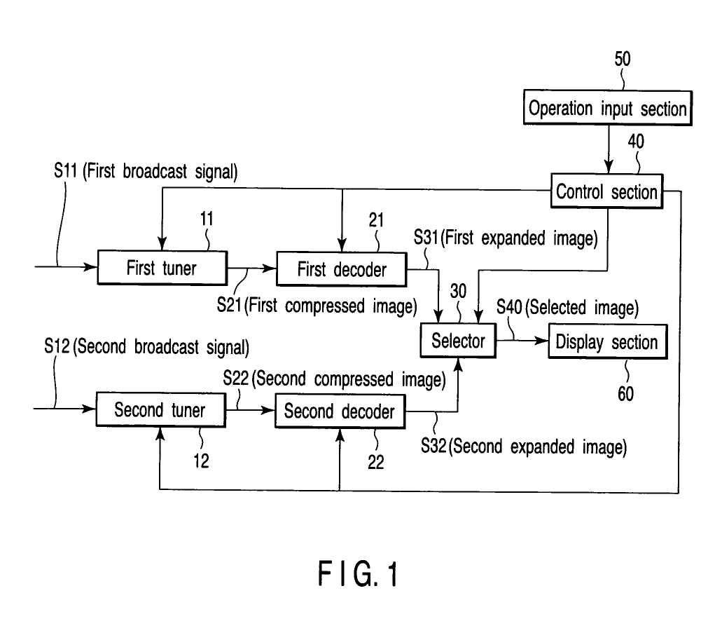

FIG. 1 schematically shows the configuration of a digital broadcast receiving apparatus (or an image output apparatus) according to a first embodiment of the present invention.

As shown in FIG. 1, the digital broadcast receiving apparatus comprises a plurality of tuners and a plurality of decoders. For example, the digital broadcast receiving apparatus comprises a first tuner 11, a second tuner 12, a first decoder 21, a second decoder 22, a select section 30, a control section 40, an operation input section 50, and a display section 60.

The operation input section 50 accepts an operation input (such as channel selection) from the user and informs the control section 40 of the input. The operation input section 50 is, for example, a remote controller. The control section 40 controls the operation of each section on the basis of the operation input notified by the operation input section 50.

The first tuner 11 tunes in to a specific channel (or a first broadcast signal S11) on the basis of a specific channel select instruction from the control section 40 (or the channel select operation by the user). The first decoder 21 expands a first compressed image S21 on the specific channel selected by the first tuner 11. Similarly, the second tuner 12 tunes in to a specific channel (or a second broadcast signal S12) on the basis of a specific channel select instruction from the control section 40 (or the channel select operation by the user). The second decoder 22 expands a second compressed image S22 on the specific channel selected by the second tuner 12. In the embodiment, compress and encode are regarded as basically the same. In addition, expand and decode are regarded as basically the same.

On the basis of the select instruction from the control section 40, the select section 30 selects one of a first expanded image S31 expanded by the first decoder 21 and a second expanded image S32 decoded by the second decoder 22 and outputs the selected image S40 to the display section 8.

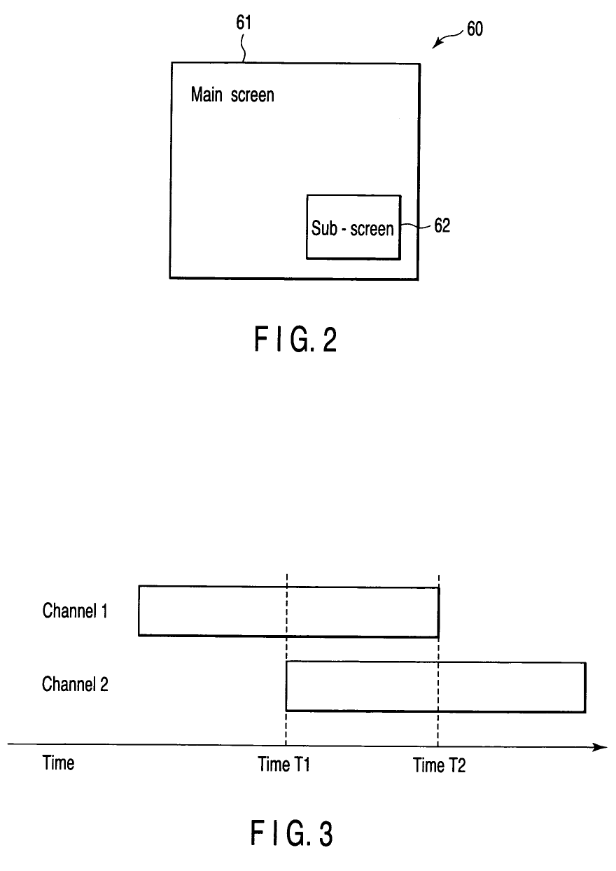

For example, the first broadcast signal S11, which is currently being watched by the viewer, is output and displayed chiefly on the main screen 61 of the display section 60. In contrast, the second broadcast signal S12 is either for the broadcast counterprogrammed to the broadcast (or the first broadcast signal S11) currently being watched by the viewer or for the broadcast output on the sub-screen 72 of the display section 60 with respect to the first broadcast signal S11 output on the main screen 61 of the display section 60 as shown in FIG. 2. As shown in FIG. 2, the main screen 61 and sub-screen 62 are displayed on the display section 60, thereby enabling the viewer to watch two broadcasts at the same time.

Here, a problem encountered in the channel switching operation in a conventional digital broadcast receiving apparatus will be explained. First, suppose the initial state where the tuner of the digital broadcast receiving apparatus receives a first broadcast signal, the decoder of the digital broadcasting receiving apparatus expands the image based on the first broadcast signal, and the display section of the digital broadcast receiving apparatus displays the expanded image. In the initial state, the viewer has intention of switching channels and instructs the digital broadcast receiving apparatus to switch to the second broadcast signal via a controller or the like. The tuner of the digital broadcast receiving apparatus stops receiving the first broadcast signal and starts to receive the second broadcast signal. Then, the decoder of the digital broadcast receiving apparatus starts to expand an image based on the second broadcast signal. The decoder of the digital broadcast receiving apparatus cannot output the image to the display section immediately after starting to expand the image. After a certain amount of time has elapsed (or after the output of the expanded image has been prepared), the decoder of the digital broadcast receiving apparatus starts to output the expanded image. The start of the output of the image completes the channel switching process.

As described above, in the conventional digital broadcast receiving apparatus, a certain amount of time is required for the tuner to selects a radio signal, the decoder to expand a compressed image, and the display section to display the expanded image on the screen. In the conventional digital broadcast receiving apparatus, during the channel switching (or the time from when a channel switching instruction is given until the image of the switched channel has been displayed), there is no image that can be output and therefore nothing is displayed on the display section (or the screen is dark).

The object of the embodiment is to provide the viewer with natural images by removing the time interval occurring in switching channels. FIG. 3 is a diagram to help explain an example of channel switching control in the digital broadcast receiving apparatus of FIG. 1. First, suppose the initial state where the tuner 11 of the digital broadcast receiving apparatus of FIG. 1 receives channel 1, the first decoder 21 of the digital broadcast receiving apparatus expands a compressed image S21 based on channel 1, and the display section 60 of the digital broadcast receiving apparatus displays an expanded image S31.

Furthermore, suppose the operation of switching from channel 1 to channel 2 occurs at time T1. Specifically, at time T1, when the viewer gives an instruction to switch channels (or select channel 2) via the operation input section 50, the control section 40 instructs the second tuner 12 to select channel 2 and the second decoder 22 to start decoding. As a result, the selection of channel 2 and an expanding process are started. Specifically, the second tuner 12 selects channel 2 and the second decoder 22 starts to decode a compressed image S22 based on channel 2.

At time T1, the control section 40 does not instruct the first tuner 11 to stop the tuning and the first decoder 21 to stop expanding the compressed image S21, with the result that the first tuner 11 continues selecting channel 1 and the first decoder 21 continues expanding the compressed image S21 based on channel 1.

Suppose the preparation of the output of the expanded image on channel 2 is completed at time T2 that a specific time has elapsed since time T1. That is, suppose a specific time (the time from time T1 to time T2) is required from when the second tuner 12 starts tuning until the second decoder 22 starts to output the expanded image. At time T2 (or after a specific time has elapsed since the start of the selection of channel 2), the select section 30 selects the expanded image based on channel 2 output from the second decoder 22 in place of the expanded image S31 based on channel 1 output from the first decoder 21. As a result, at time T2, the image displayed on the display section 60 is switched from the image on channel 1 to the image on channel 2.

As described above, during the time from when an instruction to switch to channel 2 is received until the preparation of the output of an image on channel 2 is completed (or during the time from time T1 to time T2), an image on channel 2 cannot be output. Therefore, during the switching process, the tuning of channel 1 and the expanding process are continued and an image on channel 1 is output (or the supply of more necessary information is continued). Actually, with the timing that the preparation of the output of an image on channel 2 is completed (or at time T2), the image on channel 1 is switched to the image on channel 2. As a result, it is possible to provide the viewer with channel switching without interruption in digital broadcasting as in analog broadcasting.

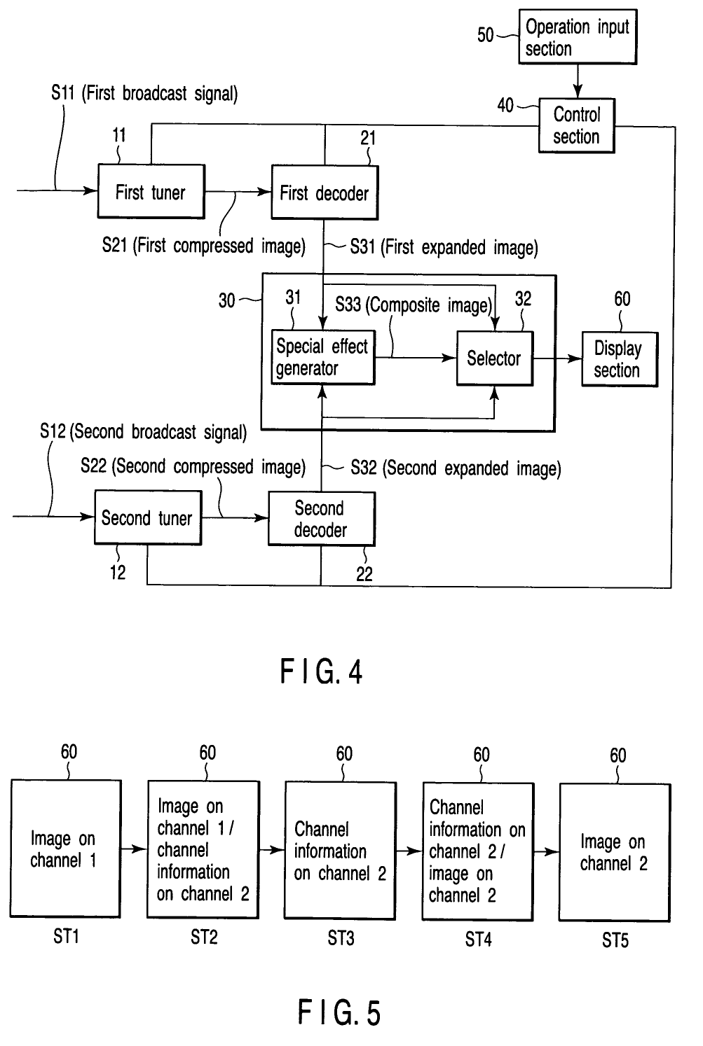

FIG. 4 schematically shows the configuration of a digital broadcast receiving apparatus (or an image output apparatus) according to a second embodiment of the present invention.

As shown in FIG. 4, the digital broadcast receiving apparatus comprises a plurality of tuners and a plurality of decoders. For example, the digital broadcasting receiving apparatus comprises a first tuner 11, a second tuner 12, a first decoder 21, a second decoder 22, a select section 30, a control section 40, an operation input section 50, and a display section 60. The select section 30 includes a special effect generator 31 and a selector 32. Hereinafter, explanation will be given, focusing on the difference between the digital broadcast receiving apparatus of the second embodiment and that of FIG. 1.

Suppose the initial state where the first tuner 11 tunes in to channel 1 (a first broadcast signal S11), the first decoder 21 expands a first compressed image S21 on channel 1, the selector 32 selects a first expanded image S31, and the display section 60 displays the first expanded image S31.

In the initial state, suppose the operation of switching from channel 1 to channel 2 occurs. Specifically, in the initial state, when the viewer gives an instruction to switch channels (or select channel 2) via the operation input section 50, the control section 40 instructs the second tuner 12 to select channel 2 and the second decoder 22 to start decoding. As a result, the selection of channel 2 and an expanding process are started. Specifically, the second tuner 12 selects channel 2 and the second decoder 22 starts to decode a compressed image S22 based on channel 2.

At this point in time, the control section 40 does not instruct the first tuner 11 to stop the tuning and the first decoder 21 to stop expanding the compressed image S21, with the result that the first tuner 11 continues selecting channel 1 and the first decoder 21 continues expanding the compressed image S21 based on channel 1.

The special effect generator 31 combines the first expanded image S31 expanded by the first decoder 21, the second expanded image S32 decoded by the second decoder 22, and special effects. The selector 32 selects the composite image S33 combined by the special effect generator 31 and outputs it to the display section 60. In the stage where all of the special effects produced by the special effect generator 31 have been output, the selector 32 selects the expanded image S32 and outputs it to the display section 60. In this stage, the process of switching from channel 1 to channel 2 is completed. As a result, the viewer can watch the broadcast more naturally without feeling a “time-gap” has occurred in switching digital broadcasting channels.

FIG. 5 is a diagram to help explain an example of transient special effects (e.g., cross-fade effects) produced by the digital broadcast receiving apparatus of FIG. 4. The digital broadcast receiving apparatus of FIG. 4 has the function of receiving and storing channel information on each channel in advance. Channel information includes channel numbers and information on the programs currently on the air. For example, when channel information is included in the broadcast signal, the first tuner 11, second tuner 12, first decoder 21, and second decoder 22 are used to acquire channel information from the broadcast signal. In addition to this, the digital broadcast receiving apparatus may access the Internet and acquire channel information via the Internet. The acquired channel information is held by, for example, the special effect generator 31.

Suppose the initial state where the tuner 11 tunes in to channel 1 (or a first broadcast signal S11), the first decoder 21 expands a first compressed image S21 on channel 1, the selector 32 selects a first expanded image S31, and the display section 60 displays the first expanded image S31 (S11).

In this state, suppose the operation of switching from channel 1 to channel 2 occurs. Specifically, in this state, when the viewer gives an instruction to switch channels (or select channel 2) via the operation input section 50, the control section 40 instructs the second tuner 12 to select channel 2, the second decoder 22 to start decoding, and the special effect generator 31 to produce special effects. As a result, the selection of channel 2 and an expanding process are started and at the same time, special effects start to be produced. Specifically, the second tuner 12 selects channel 2 and the second decoder 22 starts to decode a compressed image S22 based on channel 2. After a specific time has elapsed, the preparation of the output of images on channel 2 is completed.

Furthermore, receiving a special effect producing instruction, the special effect generator 31 reads channel information on channel 2, selects the expanded image S31 on channel 1, and combines an image of channel information on channel 2 with a 100% transparency with the expanded image S31 on channel 1 with a 0% transparency. The selector 32 starts to output the image combined by the special effect generator 31. That is, the image combined by the special effect generator 31 is displayed on the display section 60. The special effect generator 31 increases the transparency of the expanded image S31 on channel 1 gradually (a 0% transparency to a 50% transparency), while decreasing the transparency of the image of channel information on channel 2 (a 100% transparency to a 50% transparency) (ST2). Moreover, the special effect generator 31 increases the transparency of the expanded image S31 on channel 1 gradually (a 50% transparency to a 100% transparency), while decreasing the transparency of the image of channel information on channel 2 (a 50% transparency to a 0% transparency) (ST3). That is, on the display section 60, the expanded image S31 on channel 1 is faded out, whereas the image of channel information on channel 2 is faded in (ST1→ST3). At the time the image of channel information on channel 2 has been faded in completely, the preparation of image output on channel 2 has been completed (a specific time has elapsed since an instruction to switch to channel 2 was given).

Next, the special effect generator 31 selects an expanded image S32 on channel 2 and combines an image of channel information on channel 2 with a 0% transparency with the expanded image S32 on channel 2 with a 100% transparency. The special effect generator 31 decreases the transparency of the expanded image S32 on channel 2 gradually (a 100% transparency to a 50% transparency), while increasing the transparency of the image of channel information on channel 2 (a 0% transparency to a 50% transparency) (ST4). Moreover, the special effect generator 31 decreases the transparency of the expanded image S31 on channel 2 gradually (a 50% transparency to a 0% transparency), while increasing the transparency of the image of channel information on channel 2 (a 50% transparency to a 100% transparency) (ST5). That is, on the display section 60, the image of channel information on channel 2 is faded out, whereas the expanded image S32 on channel 2 is faded in (ST3→ST5). At the time the transparency of the image of channel information on channel 2 reaches 100% and the transparency of the expanded image S31 on channel 2 reaches 0%, the special effect processing by the special effect generator 31 is completed and the selector 32 selects the expanded image S31 on channel 2 from the second decoder 22.

In the prior art, the viewer cannot get any information on the next channel until the present channel has been switched to the next channel and therefore does nothing but to wait for the channel to be switched. In contrast, the embodiment enables information on the next channel (or more necessary information) to be obtained before the present channel is switched to the next channel, which improves the convenience of the viewer.

As described above, the embodiment produces the following effects:

(1) The tuner receiving the currently displayed channel is caused to operate in parallel with the channel to receive the switched channel, which eliminates an unnatural state where nothing appears on the screen while the channel switching process is being carried out.

(2) Various transient special effects are inserted during channel switching, which enables the viewer to watch more natural, substantial programs.

That is, with the embodiment, it is possible to provide an image output apparatus and an image output method which enable the channel switching waiting time to be used effectively by providing more necessary information during the channel switching waiting time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image output apparatus comprising:
a first signal processing unit configured to select a specified channel and decode an image signal on the selected channel;
a second signal processing unit configured to select a specified channel and decode an image signal on the selected channel; and
an output control unit configured to cause the second signal processing unit to start to select the second channel and decode the image signal on the second channel, while causing the first signal processing unit to continue outputting the decoded image signal on the first channel on the basis of an instruction to switch to the decoded image signal output on the second channel while the first signal processing unit is outputting the decoded image signal on the first channel, and further as a result of the completion of the preparation of the decoded image signal output on the second channel by the second signal processing unit, switch from the decoded image output on the first channel by the first signal processing unit to the decoded image output on the second channel by the second signal processing unit.

2. The image output apparatus according to claim 1, wherein the second signal processing unit requires a specific time from when a channel is selected and the decoding of an image signal is started until a decoded image is output, and
the output control unit starts to decode the image signal on the second channel from the second signal processing unit, while outputting the decoded image from the first signal processing unit on the basis of the switching instruction and after the specific time has elapsed, switches from the decoded image output on the first channel by the first signal processing unit to the decoded image output on the second channel by the second signal processing unit.

3. The image output apparatus according to claim 1, wherein the first and second signal processing units decode channel information on each channel, and
the output control unit outputs channel information on the second channel while the decoded image output on the first channel from the first signal processing unit is being switched to the decoded image output on the second channel from the second signal processing unit on the basis of the switching instruction.

4. The image output apparatus according to claim 3, wherein the output control unit fades out the decoded image on the first channel and, instead, fades in channel information on the second channel while the decoded image output on the first channel from the first signal processing unit is being switched to the decoded image output on the second channel from the second signal processing unit on the basis of the switching instruction.

5. The image output apparatus according to claim 3, wherein the output control unit fades out the decoded image on the first channel and, instead, fades in channel information on the second channel and further fades out channel information on the second channel and, instead, fades in the decoded image on the second channel while the decoded image output on the first channel from the first signal processing unit is being switched to the decoded image output on the second channel from the second signal processing unit on the basis of the switching instruction.

6. An image output method comprising:
causing a second signal processing unit configured to select a specified channel and decode an image signal on the selected channel to select a second channel and decode an image signal on the second channel while causing a first signal processing unit configured to select a specified channel and decode an image signal on the selected channel to continue outputting a decoded image on a first channel on the basis of an instruction to switch to the decoded image output on the second channel while the first signal processing unit is outputting the decoded image on the first channel; and
switching from the decoded image output on the first channel from the first signal processing unit to the decoded image output on the second channel from the second signal processing unit as a result of the completion of the preparation of the decoded image signal output on the second channel by the second signal processing unit.

7. The image output method according to claim 6, wherein the second signal processing unit requires a specific time from when a channel is selected and the decoding of an image signal is started until a decoded image is output, and
the second signal processing unit starts to decode the image signal on the second channel, while the first signal processing unit continues outputting a decoded image on the basis of the switching instruction and after the specific time has elapsed, the decoded image output on the first channel from the first signal processing unit is switched to the decoded image output on the second channel from the second signal processing unit.

8. The image output method according to claim 6, wherein the first and second signal processing units decode channel information on each channel, and
channel information on the second channel is output while the decoded image output on the first channel from the first signal processing unit is being switched to the decoded image output on the second channel from the second signal processing unit on the basis of the switching instruction.

9. The image output method according to claim 8, wherein the decoded image on the first channel is faded out and, instead, channel information on the second channel is faded in while the decoded image output on the first channel from the first signal processing unit is being switched to the decoded image output on the second channel from the second signal processing unit on the basis of the switching instruction.

10. The image output method according to claim 8, wherein the decoded image on the first channel is faded out and, instead, channel information on the second channel is faded in and further channel information on the second channel is faded out and, instead, the decoded image on the second channel is faded in while the decoded image output on the first channel from the first signal processing unit is being switched to the decoded image output on the second channel from the second signal processing unit on the basis of the switching instruction.

11. An image output apparatus comprising:
first signal processing means for selecting a specified channel and decoding an image signal on the selected channel;
second signal processing means for selecting a specified channel and decoding an image signal on the selected channel; and
output control means for causing the second signal processing means to start to select the second channel and decode the image signal on the second channel, while causing the first signal processing means to continue outputting the decoded image signal on the first channel on the basis of an instruction to switch to the decoded image signal output on the second channel while the first signal processing means is outputting the decoded image signal on the first channel, and further as a result of the completion of the preparation of the decoded image signal output on the second channel by the second signal processing means, switching from the decoded image output on the first channel by the first signal processing means to the decoded image output on the second channel by the second signal processing means.

12. The image output apparatus according to claim 11, wherein the second signal processing means requires a specific time from when a channel is selected and the decoding of an image signal is started until a decoded image is output, and
the output control means starts to decode the image signal on the second channel from the second signal processing means, while outputting the decoded image from the first signal processing means on the basis of the switching instruction and after the specific time has elapsed, switches from the decoded image output on the first channel by the first signal processing means to the decoded image output on the second channel by the second signal processing means.

13. The image output apparatus according to claim 11, wherein the first and second signal processing means decode channel information on each channel, and
the output control means outputs channel information on the second channel while the decoded image output on the first channel from the first signal processing means is being switched to the decoded image output on the second channel from the second signal processing means on the basis of the switching instruction.

14. The image output apparatus according to claim 13, wherein the output control means fades out the decoded image on the first channel and, instead, fades in channel information on the second channel while the decoded image output on the first channel from the first signal processing means is being switched to the decoded image output on the second channel from the second signal processing means on the basis of the switching instruction.

15. The image output apparatus according to claim 13, wherein the output control means fades out the decoded image on the first channel and, instead, fades in channel information on the second channel and further fades out channel information on the second channel and, instead, fades in the decoded image on the second channel while the decoded image output on the first channel from the first signal processing means is being switched to the decoded image output on the second channel from the second signal processing means on the basis of the switching instruction.
